(19) United States
(12) Patent Application Publication
(10) Pub. No.: US 2026/0283113 A1
(43) Pub. Date: Sep. 24, 2026

(54) Movable Animal Toy Suspension Device

(71) Applicant: Shantee Tiller, Charlotte, NC (US)

(72) Inventor: Shantee Tiller, Charlotte, NC (US)

(21) Appl. No.: 19/238,996

(22) Filed: Jun. 16, 2025

Related U.S. Application Data
(60) Provisional application No. 63/774,219, filed on Mar. 19, 2025.

(51) Int. Cl. A01K 15/02

(52) U.S. Cl. CPC A01K 15/025

(57) ABSTRACT

A movable animal toy suspension device is provided. The device is comprised of a free-standing frame comprised of legs and a cross member. In one embodiment, the legs are telescopic and height-adjustable through locking mechanisms and may be comprised of stabilizing elements. The horizontal cross member spans between the legs and incorporates a longitudinal track designed to house movable capture units. Each capture unit comprises a swivel hook assembly configured for 360-degree rotation and includes one or more lines attached therefrom. The lines are attached to various toys that are suspended in the air above the cross member. The lines may be adjustable in length further allowing for dynamic play. During operation, the suspended toys can be struck, pulled, or chased by dogs or other animals, resulting in swinging and lateral motion that simulates natural prey behavior.

### CROSS-REFERENCE TO RELATED APPLICATION

The present application claims priority to, and the benefit of, U.S. Provisional Application No. 63/774,219, which was filed on Mar. 19, 2025, and is incorporated herein by reference in its entirety.

### FIELD OF THE INVENTION

The present invention relates generally to the field of animal amusement toys. More specifically, the present invention relates to a device that suspends a plurality of movable animal toys in the air that animals can interact with. Accordingly, the present disclosure makes specific reference thereto. Nonetheless, it is to be appreciated that aspects of the present invention are also equally applicable to other like applications, devices, and methods of manufacture.

### BACKGROUND

Dogs (and other animals) require consistent physical activity and mental stimulation to maintain their health and well-being. Without adequate exercise, dogs are prone to developing obesity-related conditions, joint issues, and cardiovascular problems. Additionally, the absence of mental engagement and social interaction may lead to behavioral issues such as anxiety, depression, or destructiveness. While regular play sessions can help mitigate these concerns, not all pet owners are physically able to engage their dogs in active play. Factors such as age, mobility limitations, or time constraints may hinder a pet owner's capacity to participate in physically demanding activities. This limitation often results in missed opportunities for both exercise and bonding between the pet and its owner. Furthermore, there is a growing demand for play solutions that can serve both domestic and institutional settings, such as animal shelters, pet daycare centers, and therapeutic environments. In these contexts, the need for an engaging, low effort, yet interactive canine play system becomes more pronounced. A solution is required that can promote physical and cognitive engagement for animals while being accessible and easy to use for a broad range of users.

Therefore, there exists a long-felt need in the art for a movable animal toy suspension device that enables dogs to engage in independent physical activity without constant human intervention. There also exists a long-felt need in the art for a movable animal toy suspension device that accommodates the physical limitations of pet owners while maintaining interactive play opportunities. Moreover, there exists a long-felt need in the art for a movable animal toy suspension device that can be deployed in a variety of settings including homes, parks, and therapeutic environments.

The subject matter disclosed and claimed herein, in one embodiment thereof, comprises a movable animal toy suspension device. The device is comprised of a free-standing frame comprised of legs and a cross member. In one embodiment, the legs are telescopic and height-adjustable through locking mechanisms and may be comprised of stabilizing elements. The horizontal cross member spans between the legs and incorporates a longitudinal track designed to house movable capture units. Each capture unit comprises a swivel hook assembly configured for 360-degree rotation and includes one or more lines attached therefrom. The lines are attached to various toys that are suspended in the air above the cross member. The lines may be adjustable in length further allowing for dynamic play. During operation, the suspended toys can be struck, pulled, or chased by dogs (or other animals), resulting in swinging and lateral motion that simulates natural prey behavior. The device is configured to support multiple simultaneous users and provides both static and dynamic interaction options to accommodate diverse animal behaviors.

In this manner, the movable animal toy suspension device of the present invention accomplishes all the forgoing objectives and provides a device that enables independent and stimulating exercise for dogs (and other animals), thereby addressing the physical and mental health concerns associated with inactivity. The inclusion of height-adjustable legs and interchangeable toy configurations allows pet owners with limited mobility to engage their animals in active play without excessive exertion. Furthermore, the modular design and durable construction of the device make it suitable for installation in diverse environments including residential areas, public dog parks, and clinical therapy settings. By enabling a wide range of canine activities and owner involvement levels, the device provides an adaptable and inclusive solution for modern animal recreation needs.

### SUMMARY

The following presents a simplified summary to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a movable animal toy suspension device. The device is a free-standing play structure for animals, designed to encourage physical activity and cognitive stimulation through various suspended interactive toys. The device is comprised of a frame, preferably in an A-frame configuration, formed by two pairs of angled legs. The legs may be constructed from durable materials and may be telescopic with height adjustability enabled by locking mechanisms. The lower ends of the legs may incorporate stabilizing elements such as rubberized foot pads, anchoring spikes, base plates, or weighted pads.

A horizontal cross member spans between the legs and serves as the main load-bearing structure for the suspended toy mechanisms. The cross member is connected to the legs via connecting members. The cross member may feature a longitudinal track with a channel profile that retains and guides movable capture units. Each capture unit is independently mobile within the track and includes a swivel hook assembly that allows full 360-degree vertical axis rotation. At least one line is attached to each swivel hook assembly. At least one toy is attached to each line, with variations in type, size, weight, and material.

During use, animals interact with the toys by pulling or striking the toys, which induces swinging and lateral motion along the track. Multiple toys may be positioned along the track to allow simultaneous play for multiple animals. As a result, the device supports both stationary and dynamic play configurations, accommodating a wide range of animal temperaments and activity levels.

A method of use also comprises the steps of deploying the frame, adjusting the leg height if needed, securing the lines to the swivel hooks, attaching toys to the lines by removable or permanent methods, optionally using fixed eyelets for stationary play, and enabling animal interaction with the toys to facilitate movement and engagement. Another method of use to the left and right ends of the A-frame are two closed screw eyes which allows for the attachment of stronger toys for tugging movement and engagement.

Accordingly, the movable animal toy suspension device of the present invention is particularly advantageous as it provides a device that enables independent and stimulating exercise for dogs (and other animals), thereby addressing the physical and mental health concerns associated with inactivity. The inclusion of height-adjustable legs and interchangeable toy configurations allows pet owners with limited mobility to engage their animals in active play without excessive exertion. Furthermore, the modular design and durable construction of the device make it suitable for installation in diverse environments including residential areas, public dog parks, and clinical therapy settings. Therefore, by enabling a wide range of canine activities and owner involvement levels, the device provides an adaptable and inclusive solution for modern animal recreation needs.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of a movable animal toy suspension device of the present invention in accordance with the disclosed architecture; and

FIG. 2 illustrates a flowchart of a method of using one potential embodiment of a movable animal toy suspension device of the present invention in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth to provide a thorough understanding thereof. It may be evident, however, that the innovation can be practiced without these specific details. In other instances, well-known structures and devices are shown in block diagram form to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for a movable animal toy suspension device that enables dogs to engage in independent physical activity without constant human intervention. There also exists a long-felt need in the art for a movable animal toy suspension device that accommodates the physical limitations of pet owners while maintaining interactive play opportunities. Moreover, there exists a long-felt need in the art for a movable animal toy suspension device that can be deployed in a variety of settings including homes, parks, and therapeutic environments.

The present invention, in one exemplary embodiment, is comprised of a movable animal toy suspension device. The device is configured to promote physical activity and cognitive engagement through the use of suspended interactive toys. The device includes a frame, preferably designed in an A-frame configuration, which is formed by two pairs of angled legs. These legs may be manufactured from durable materials and are optionally telescopic, allowing for height adjustment via integrated locking mechanisms. Stabilizing elements such as rubberized foot pads, anchoring spikes, base plates, or weighted pads may be provided at the lower ends of the legs to ensure stability during use.

A horizontal cross member extends between the legs and functions as the primary load-bearing component for the suspended toy assemblies. This cross member is joined to the legs through one or more connecting members and may include a longitudinal track with a defined channel geometry to retain and guide movable capture units. Each capture unit is capable of independent lateral movement within the track and includes a swivel hook assembly that enables 360-degree rotation around a vertical axis. One or more lines are suspended from the swivel hook assemblies, and each line supports at least one toy, with variations in type, size, weight, and material.

During operation, animals interact with the suspended toys by pulling or striking them, which causes both swinging and lateral movement along the track. Multiple toys may be arranged along the track to facilitate simultaneous use by multiple animals. This configuration supports both stationary and dynamic modes of play, thereby accommodating a broad spectrum of animal energy levels and behavioral preferences.

A method of use includes the sequential steps of deploying the frame, adjusting the height of the legs as necessary, securing the lines to the swivel hook assemblies, attaching toys to the lines either removably or permanently, optionally connecting lines to fixed eyelets for static play, and allowing animals to engage with the toys to initiate motion and interactive behavior.

As a result, the movable animal toy suspension device described herein provides a practical and stimulating exercise solution for dogs and other animals, addressing concerns related to inactivity and insufficient mental stimulation. Features such as height-adjustable legs and interchangeable toy options enable participation by pet owners with limited mobility. The durable and modular construction further enhances suitability for various installation environments, including residential spaces, public dog parks, and therapeutic settings. By supporting a diverse range of canine activities and owner involvement levels, the device delivers a flexible and inclusive approach to modern animal recreation.

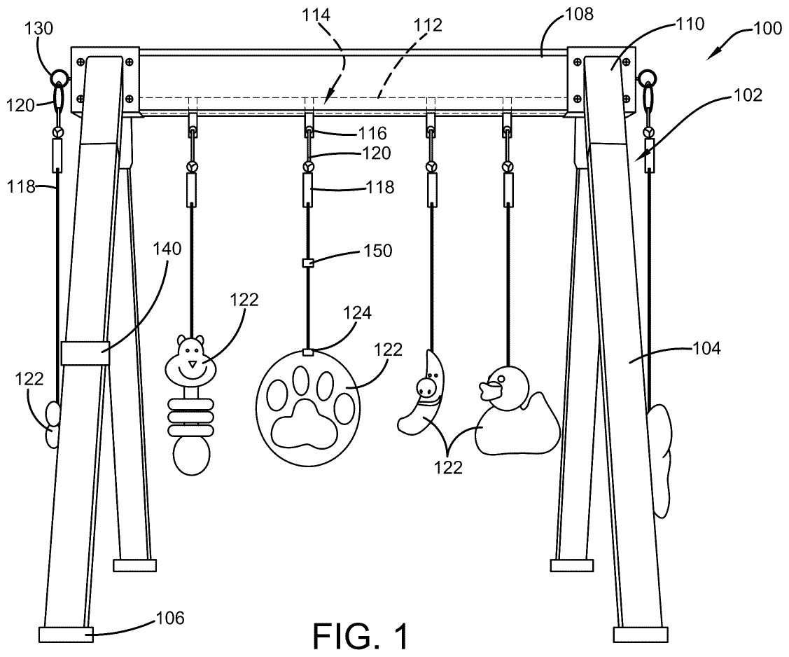

Referring initially to the drawings, FIG. 1 illustrates a perspective view of one potential embodiment of a movable animal toy suspension device of the present invention in accordance with the disclosed architecture. The device 100 is a free-standing play structure specifically designed for animals, promoting physical activity and cognitive stimulation through a variety of interactive suspended toys. The device 100 may be utilized in residential backyards, pet daycare facilities, animal shelters, or any open area suitable for animal recreation.

The device 100 is comprised of a frame 102. The frame 102 is preferably but not limited to an A-frame design, comprised of two pairs of angled legs 104 forming a triangular stance. Each leg 104 may be manufactured from durable materials such as but not limited to powder-coated steel, aluminum alloy, reinforced polymer composites, or treated wood. In one embodiment, the legs 104 are telescopic and may be height adjustable, wherein the height of each leg 104 can be secured via at least one locking mechanism 140. The locking mechanism 140 may include but is not limited to twist locks, spring-loaded detents, or pin-and-hole systems configured to maintain the extended or retracted position of the legs 104 during use. This telescoping feature allows the frame 102 to be adapted for various user environments, animal sizes, or ground inclinations.

The lower ends of the legs 104 may include stabilizing elements 106 (as seen in FIG. 1) such as but not limited to rubberized foot pads, anchoring spikes, base plates, or weighted pads to prevent lateral displacement or tipping of the device 100 during active use. In alternative embodiments, the stabilizing elements 106 are in the form of ground-engaging features, such as but not limited to auger-style anchoring screws, stakes, etc. for semi-permanent installations.

At least one horizontal cross member 108 spans between the legs 104 and serves as the primary load-bearing element for the suspended toy mechanisms, as will be explained more fully below. The connection between the cross member 108 and the legs 104 is achieved through at least one connecting member 110 (as seen in FIG. 1) such as but not limited to gusseted brackets, locking hinges, bolted joint plates, or pivot couplings.

The cross member 108 may be comprised of a longitudinal track 112 that functions as a guide rail for movable capture units 114, as seen in FIG. 1. The track 112 may feature channel geometries such as but not limited to C-shaped, T-shaped, dovetail, or I-beam profiles, selected to retain and guide the capture units 114 while permitting smooth lateral motion of the units 114 along the cross member 108 via the track 112. Each capture unit 114 is preferably independently mobile and remains secured within the track 112.

Each capture unit 114 may include a swivel hook assembly 116, as seen in FIG. 1. The swivel hook assembly 116 enables full 360-degree vertical axis rotation and may be a ball-bearing swivel mechanism, a universal joint, etc. At least one line 118 attaches to each swivel hook assembly 116. The line 118 may be in the form of static ropes, stretchable elastic bands, bungee cords, retractable cable mechanisms, etc. depending on the desired play dynamics. The lines 118 are connected to the swivel hooks 116 using at least one fastener 120 such as but not limited to carabiners, snap hooks, locking pins, quick-release buckles, etc. to facilitate easy interchange.

In addition to the movable capture units 114, the device 100 may also be comprised of fixed eyelets 130 that serve as static attachment points for lines 118 via the fasteners 120. These eyelets 130 may be distributed along the legs 104 or cross member 108 and may be in the form of but is not limited to grommet-style mounts, D-rings, or welded loops.

At least one toy 122 may be attached to each line 118, as seen in FIG. 1. Each toy 122 may vary in type, size, weight, and material to accommodate different animal preferences and may include but is not limited to squeaky toys, plush items, chew ropes, tires, food-dispensing toys, textured rubber toys, floating water toys, braided fabric strips, knotted ropes, rubber balls, plastic cones, rope-and-ball hybrids, frozen treat holders, etc. The toys 122 may be removably attached to the lines 118 via a fastener 124 such as but not limited to clips, clamps, knots, hook and loop straps, magnetic couplings, D-rings, latching loops, plastic buckles, twist ties, bungee loops, or screw-lock connectors. In one embodiment, toys 122 are fixedly attached to the lines 118 through permanent methods such as adhesive bonding, molded integration, or sewn attachment, thereby preventing removal or interchange by the user or the dog during use.

During interaction, dogs may pull, strike, or chase the toys 122 suspended from the lines 118, causing the toys 122 to swing and slide laterally along the track 112. In one embodiment, the line 118 may be adjustable in length via at least one fastener 150. The fastener 150 may include but is not limited to cam locks, cord locks, spring clamps, buckle adjusters, ratcheting sliders, or cinch mechanisms, allowing precise control over the height at which the toys 122 are suspended. This results in a dynamic and engaging play experience that mimics prey movement, encouraging natural canine behaviors such as stalking, pouncing, tugging, and chasing. Multiple toys 122 may be suspended from different lines 118 and positions on the track 112, allowing for simultaneous play by multiple dogs without interference.

By integrating both stationary and dynamic play options, the device 100 supports a wide range of canine temperaments and energy levels. The device 100 promotes physical health, reduces boredom, and enhances mental stimulation, thereby contributing to overall canine well-being in a durable and versatile format.

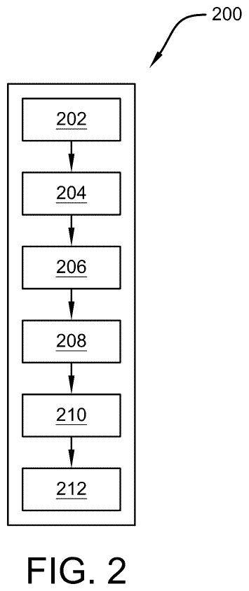

The present invention is also comprised of a method of using 200 the device 100, as seen in FIG. 2. First, a device 100 is provided comprised of a frame 102 comprised of at least two pairs of legs 104, at least one horizontal cross member 108, and at least one line 118 suspending at least one toy 122 [Step 202]. Then, the frame 102 is deployed, wherein the legs 104 may be height-adjusted using at least one locking mechanism 140 if present [Step 204]. Then, at least one line 118 is secured to each swivel hook assembly 116 via at least one fastener 120, and wherein each line 118 is optionally adjustable in length using at least one fastener 150 [Step 206]. Then, at least one toy 122 is attached to each line 118 using at least one fastener 124 or by permanent attachment methods such as adhesive bonding, molded integration, or sewn connection [Step 208]. Alternatively, or additionally, at least one line 118 may be secured to at least one fixed eyelet 130 for stationary play [Step 210]. Finally, one or more animals may interact with the toys 122 by tugging, chasing, or striking the toys 122, thereby initiating swinging and lateral motion of the toys 122 to promote physical activity and cognitive engagement [Step 212].

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “movable animal toy suspension device” and “device” are interchangeable and refer to the movable animal toy suspension device 100 of the present invention.

Notwithstanding the forgoing, the movable animal toy suspension device 100 of the present invention and its various components can be of any suitable size and configuration as is known in the art without affecting the overall concept of the invention, provided that they accomplish the above-stated objectives. One of ordinary skill in the art will appreciate that the size, configuration, and material of the movable animal toy suspension device 100 as shown in the FIGS. are for illustrative purposes only, and that many other sizes and shapes of the movable animal toy suspension device 100 are well within the scope of the present disclosure. Although the dimensions of the movable animal toy suspension device 100 are important design parameters for user convenience, the movable animal toy suspension device 100 may be of any size, shape, and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

1. A movable animal toy suspension device comprising:
a frame comprised of a first leg and a second leg;
a horizontal cross member spanning between the first leg and the second leg;
a capture unit movably coupled to the horizontal cross member within a track;
a swivel hook assembly attached to the capture unit;
a line attached to the swivel hook assembly; and
a toy attached to the line;
wherein the first leg is a telescoping leg adjustable in height via a twist lock;
wherein the toy attaches to the line via a hook and loop strap fastener; and
further wherein the capture unit is mobile within the track.

2. (canceled)

3. (canceled)

4. The movable animal toy suspension device of claim 1, wherein the first leg attaches to the horizontal cross member via a connecting member.

5. The movable animal toy suspension device of claim 1, wherein the line is comprised of an elastic band or a bungee cord.

6. (canceled)

7. (canceled)

8. (canceled)

9. A movable animal toy suspension device comprising:
a frame comprised of a first leg and a second leg;
a horizontal cross member spanning between the first leg and the second leg;
a capture unit movably coupled to the horizontal cross member within a track;
a swivel hook assembly attached to the capture unit;
an eyelet;
a line attached to the swivel hook assembly; and
a toy attached to the line; and
wherein each leg comprises a weighted foot pad and an auger anchoring screw; and
wherein the track is a dovetail channel track.

10. (canceled)

11. The movable animal toy suspension device of claim 9, wherein the first leg is comprised of a base plate.

12. (canceled)

13. The movable animal toy suspension device of claim 9, wherein the first leg is comprised of a telescopic leg.

14. The movable animal toy suspension device of claim 13, wherein the first leg is comprised of a locking mechanism.

15. The movable animal toy suspension device of claim 9, wherein the first leg attaches to the horizontal cross member via a connecting member.

16. The movable animal toy suspension device of claim 9, wherein the line is comprised of an elastic band or a bungee cord.

17. The movable animal toy suspension device of claim 9, wherein the toy attaches to the line via a fastener.

18. The movable animal toy suspension device of claim 17, wherein the fastener is comprised of a clip, a clamp, a hook and loop strap, a magnetic coupling, or a buckle.

19. The movable animal toy suspension device of claim 9, wherein the capture unit is mobile within the track.

20. A method of using a movable animal toy suspension device, the method comprising the following steps:
providing a moveable animal toy suspension device comprising a frame having a leg, a horizontal cross member, and a line suspending a toy;
deploying the frame by positioning the leg;
securing the line to a swivel hook assembly using a fastener;
magnetically attaching the toy to the line;
adjusting a length of the line via a line length buckle adjuster; and
allowing an animal to interact with the toy to induce a swinging and a lateral motion of the toy.
